(19) United States
(12) Patent Application Publication
(10) Pub. No.: US 2025/0035220 A1
(43) Pub. Date: Jan. 30, 2025

(54) VALVE DEVICE

(71) Applicant: MIKUNI CORPORATION, Tokyo (JP)

(72) Inventor: Satoshi SEKIGUCHI, Kanagawa (JP)

(73) Assignee: MIKUNI CORPORATION, Tokyo (JP)

(21) Appl. No.: 18/731,369

(22) Filed: Jun. 3, 2024

(30) Foreign Application Priority Data
Jul. 25, 2023 (JP) 2023-121078

(51) Int. Cl. F16K 11/048; F16K 27/02; F16K 31/06

(52) U.S. Cl. CPC F16K 11/048; F16K 27/0263; F16K 31/0634

(57) ABSTRACT

Provided is a valve device in which a valve body can come into close contact with a valve seat to reliably close the valve even if a shaft moves slightly off-axis or tilted. In a valve device including: a housing 10 defining an upstream passage 12a and downstream passages 13a and 14a through which a fluid passes, and valve seats 11d and 11e interposed between the upstream passage and the downstream passages; a shaft 60 reciprocating along a predetermined axis S; and valve bodies 20 and 30 fixed to the shaft and seated on and separated from the valve seats, the valve seats 11d and 11e are formed into annular tapered surfaces forming a part of conical surfaces centered on the axis, and the valve bodies 20 and 30 are formed to include convex curved surfaces 22a and 32a that come into contact with the annular tapered surfaces when seated.

### CROSS-REFERENCE TO RELATED APPLICATION

This application claims the priority benefits of Japanese application no. 2023-121078, filed on Jul. 25, 2023. The entirety of the above-mentioned patent application is hereby incorporated by reference herein and made a part of this specification.

### BACKGROUND

### Technical Field

The disclosure relates to a valve device including a valve body that is seated on a valve seat to close the valve, and particularly relates to a valve device including a valve body fixed to a shaft that reciprocates linearly.

### Description of Related Art

As a conventional valve device, there is a check valve which includes a housing (curved pipe, valve box) having an inflow path, an outflow path, and a planar valve seat interposed between the inflow path and the outflow path; a valve body integrally formed with a valve shaft that reciprocates within the housing; a flat plate-shaped packing member attached to the valve body so as to contact the valve seat when the valve is closed; and a spring body urging the valve body in the valve-closing direction (see, for example, Patent Document 1 (Japanese Patent Application Laid-Open No. 2016-75357)).

In this check valve, the packing member is formed on a flat surface, and the valve seat is formed on a flat surface. Therefore, if the valve shaft is slightly tilted, the packing member may not come into close contact with the valve seat, making it impossible to reliably close the valve.

As another valve device, an electromagnetic control valve is known, which includes a housing having an intake port, an exhaust port, and a valve seat interposed between the intake port and the exhaust port; a shaft reciprocating within the housing; a valve member and a rubber member fixed to the end portion of the shaft; a compression spring urging the valve member in the valve-closing direction; and a solenoid that includes a movable iron core, a fixed iron core, and an electromagnetic coil fixed to the shaft (see, for example, Patent Document 2 (Japanese Patent Application Laid-Open No. 62-56679)).

In this electromagnetic control valve, the valve seat is formed as a flat surface perpendicular to the reciprocating direction of the shaft, and the rubber member is formed to include a flat surface facing the valve seat and an annular protrusion protruding from the flat surface. However, the top of the annular protrusion is located on a substantially flat surface, so if the shaft is slightly tilted, the rubber member may not come into close contact with the valve seat, making it impossible to reliably close the valve.

In view of the above circumstances, the disclosure provides a valve device in which the valve body can be brought into close contact with the valve seat to reliably close the valve even if the shaft moves slightly off-axis or tilted.

### SUMMARY

A valve device of the disclosure includes: a housing that defines an upstream passage and a downstream passage through which a fluid passes, and a valve seat which is interposed between the upstream passage and the downstream passage; a shaft that reciprocates along a predetermined axis; and a valve body that is fixed to the shaft, and seated on and separated from the valve seat, in which the valve seat is formed into an annular tapered surface which forms a part of a conical surface centered on the axis, and the valve body is formed to include a convex curved surface which comes into contact with the annular tapered surface when seated on the valve seat.

In the above valve device, the convex curved surface may be formed to include a part of a spherical surface which has a center on the axis.

In the above valve device, the valve seat may be defined by a circular inner edge and a circular outer edge centered on the axis, the valve body may include an outer peripheral edge which has an outer diameter equal to or smaller than a diameter of the circular outer edge, and the convex curved surface may be formed over a predetermined range which extends inward in a radial direction from the outer peripheral edge.

In the above valve device, the valve body may include a valve base member fixed to the shaft, and an elastic sealing member fixed to the valve base member, and the convex curved surface may be formed on the elastic sealing member.

In the above valve device, the valve base member may include a hub portion fixed to the shaft, and an annular plate portion extending from an outer periphery of the hub portion in a radial direction perpendicular to the axis, and the elastic sealing member may be joined to cover the annular plate portion.

In the above valve device, the elastic sealing member and the hub portion may be formed to have the same thickness dimension in a direction of the axis.

In the above valve device, the valve base member may include an uneven surface at a joint interface of the elastic sealing member.

In the above valve device, the elastic sealing member may be molded to the valve base member.

In the above valve device, the valve body may be formed to be rotationally symmetrical around the axis and plane symmetrical with respect to a plane perpendicular to the axis.

In the above valve device, the downstream passage may include a first downstream passage and a second downstream passage which branch from the upstream passage, the valve seat may include a first valve seat facing the first downstream passage and a second valve seat facing the second downstream passage, and the valve body may include a first valve body corresponding to the first valve seat and a second valve body corresponding to the second valve seat, in which the first valve body and the second valve body are spaced apart from each other in a direction of the axis.

In the above valve device, the first valve body may be in an open state of being separated from the first valve seat in a state where the second valve body is in a closed state of being seated on the second valve seat, and the second valve body may be in an open state of being separated from the second valve seat in a state where the first valve body is in a closed state of being seated on the first valve seat.

The above valve device may further include a drive unit that drives the shaft.

In the above valve device, the drive unit may include a movable element to which the shaft is fixed, an excitation coil, and a stator which forms a magnetic path, and the shaft may be made of a non-magnetic material.

In the above valve device, the valve base member may be made of a non-magnetic material, and the elastic sealing member may be made of a rubber material.

In the above valve device, the first valve body and the second valve body may be fixed to the shaft by fitting, and the housing may include: a housing body that includes a joint surface which joins the drive unit, a first opening which is formed inside the joint surface and to which the first valve body is inserted from one side in the direction of the axis, the first valve seat and the second valve seat which are sequentially arranged in the direction of the axis following the first opening, and a second opening to which the second valve body is inserted from the other side in the direction of the axis; and a housing cover that is coupled to the housing body so as to close the second opening.

In the above valve device, the shaft may include a positioning portion that positions the second valve body in the direction of the axis.

According to the valve device having the above configuration, even if the shaft moves slightly off-axis or tilted, the valve body can be brought into close contact with the valve seat to reliably close the valve.

### BRIEF DESCRIPTION OF THE DRAWINGS

FIG. 1 is an external perspective view of the valve device according to an embodiment of the disclosure, viewed from the drive unit side.

FIG. 2 is an external perspective view of the valve device according to an embodiment, viewed from the side opposite to the drive unit.

FIG. 3 is a cross-sectional view of the valve device according to an embodiment, taken along a plane passing through the axis.

FIG. 4 is an exploded perspective view of the drive unit that forms a part of the valve device according to an embodiment, exploded along the axis.

FIG. 5 is a cross-sectional view of the drive unit that forms a part of the valve device according to an embodiment, taken along a plane that includes the axis.

FIG. 6 is an external perspective view showing the housing that forms a part of the valve device according to an embodiment.

FIG. 7 is an exploded cross-sectional view of the housing that forms a part of the valve device according to an embodiment.

FIG. 8 is a perspective cross-sectional view showing the region of the first valve seat of the housing in the valve device according to an embodiment.

FIG. 9 is a perspective cross-sectional view showing the region of the second valve seat of the housing in the valve device according to an embodiment.

FIG. 10 is a partial view showing the valve bodies (first valve body, second valve body) fixed to the shaft in the valve device according to an embodiment.

FIG. 11 is a perspective cross-sectional view showing the valve bodies (first valve body, second valve body) included in the valve device according to an embodiment.

FIG. 12 is a partial cross-sectional view of the valve bodies (first valve body, second valve body) included in the valve device according to an embodiment.

FIG. 13 is a schematic diagram showing the relationship between the first valve body, the shaft, and the first valve seat included in the valve device according to an embodiment.

FIG. 14 is a schematic diagram showing the relationship between the second valve body, the shaft, and the second valve seat included in the valve device according to an embodiment.

FIG. 15 is a cross-sectional view showing the open and closed states of the valve bodies (first valve body, second valve body) when the drive unit is at the non-energized rest position in the valve device according to an embodiment.

FIG. 16 is a cross-sectional view showing the open and closed states of the valve bodies (first valve body, second valve body) when the drive unit is energized and at the operating position in the valve device according to an embodiment.

FIG. 17 is a process view illustrating the assembly work of the valve device according to an embodiment.

FIG. 18 is a process view illustrating the assembly work of the valve device according to an embodiment.

FIG. 19 is a process view illustrating the assembly work of the valve device according to an embodiment.

FIG. 20 is a process view illustrating the assembly work of the valve device according to an embodiment.

### DESCRIPTION OF THE EMBODIMENTS

Embodiments of the disclosure will be described below with reference to the accompanying drawings.

The valve device of the disclosure is applied to, for example, a cooling water circulation system or the like of a vehicle to adjust the flow of cooling water as a fluid.

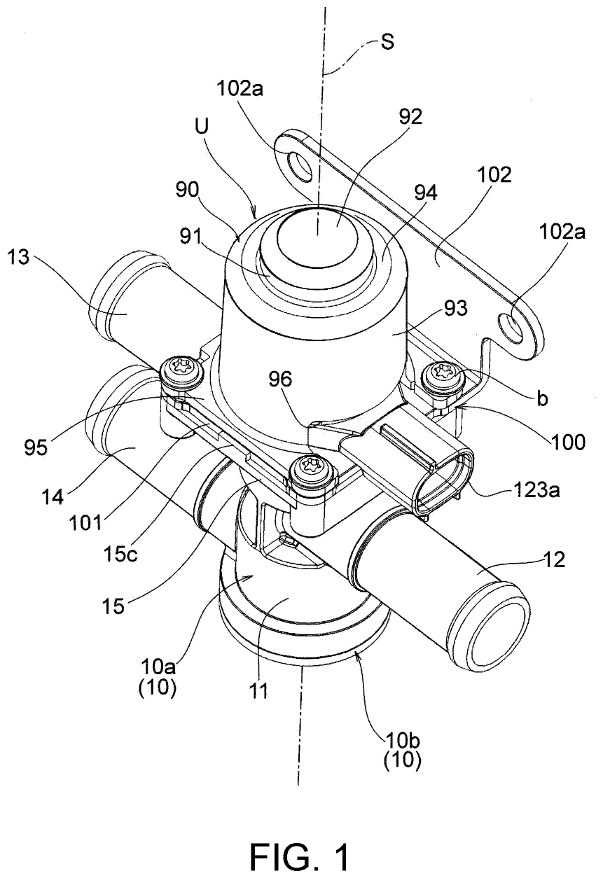

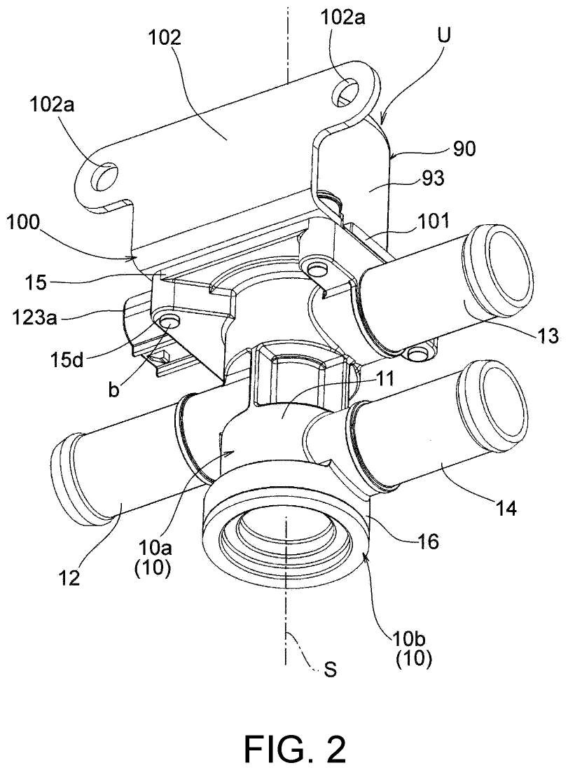

As shown in FIG. 1 to FIG. 3, the valve device according to an embodiment includes a housing 10, a first valve body 20 and a second valve body 30 as valve bodies, a sealing member 40, and a drive unit U fixed to the housing 10.

The housing 10 is made of a resin material or the like, and includes a housing body 10a and a housing cover 10b.

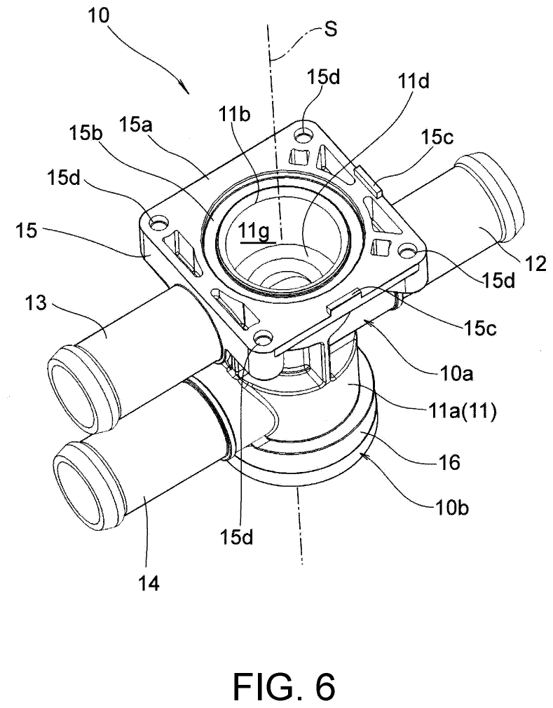

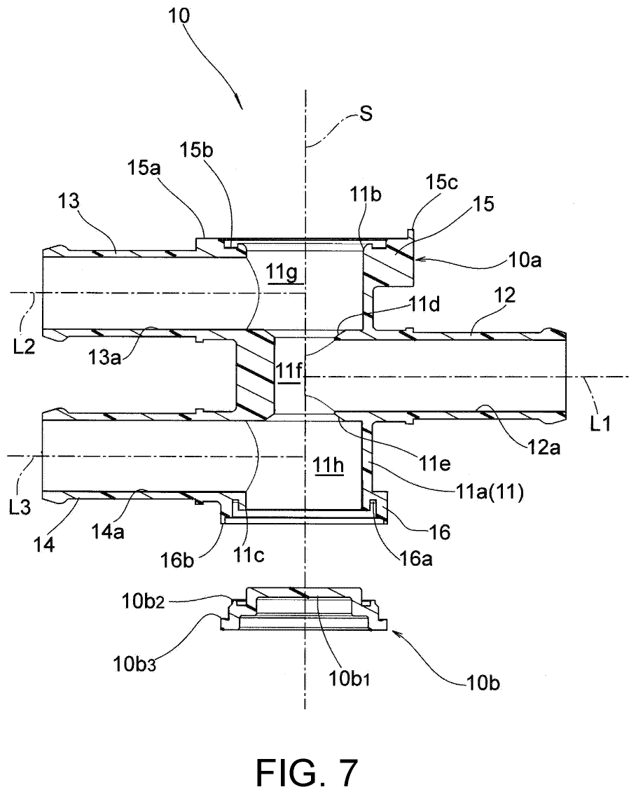

As shown in FIG. 6 and FIG. 7, the housing body 10a includes a cylindrical portion 11, an upstream pipe portion 12, a first downstream pipe portion 13, a second downstream pipe portion 14, a flange portion 15, and a cover coupling portion 16.

The cylindrical portion 11 is formed into a substantially cylindrical shape centered on an axis S, and includes a side wall 11a, a first opening 11b, a second opening 11c, a first valve seat 11d, a second valve seat 11e, a central chamber 11f, a first working chamber 11g, and a second working chamber 11h.

The first opening 11b is a circular hole centered on the axis S on the inside of a joint surface 15a of the flange portion 15 so as to face the first working chamber 11g, and is formed so that the first valve body 20 can be inserted from one side in the direction of the axis S. Then, the first opening 11b is closed by joining the drive unit U with the sealing member 40 sandwiched therebetween.

The second opening 11c is a circular hole centered on the axis S on the inside of the cover coupling portion 16 so as to face the second working chamber 11h, and is formed so that the second valve body 30 can be inserted from the other side in the direction of the axis S. Then, after the second valve body 30 is assembled, the second opening 11c is closed by coupling with the housing cover 10b.

The first valve seat 11d is a region on which the first valve body 20 is seated, and is formed into an annular tapered surface that forms a part of a conical surface centered on the axis S and widens toward the side of the first opening 11b.

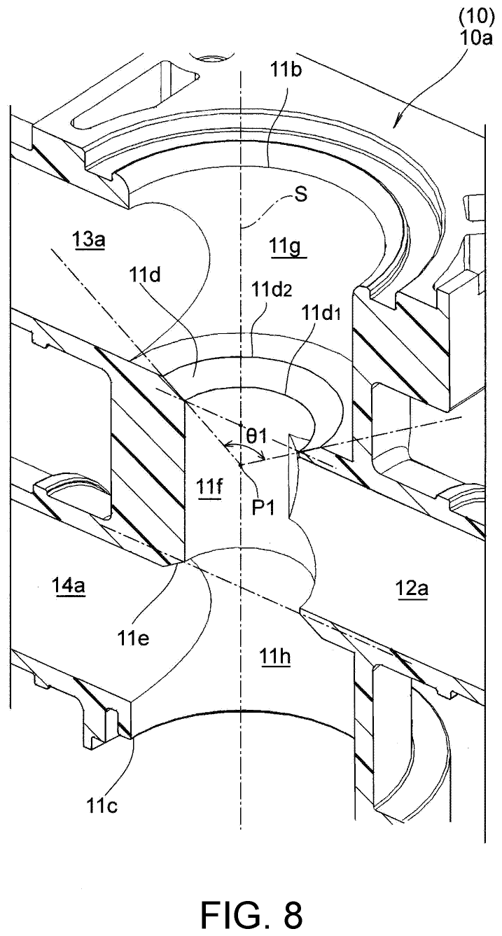

That is, as shown in FIG. 8, the first valve seat 11d is formed as a part of a conical surface that widens at an apex angle θ1 from an apex P1 located near the central chamber 11f toward the side of the first working chamber 11g on the axis S, and is defined by a circular inner edge 11d₁ and a circular outer edge 11d₂.

Here, the apex angle θ1 is formed in a range of about 110 degrees to 120 degrees, for example, and is set to about 115 degrees here.

The second valve seat 11e is a region on which the second valve body 30 is seated, and is formed into an annular tapered surface that forms a part of a conical surface centered on the axis S and widens toward the side of the second opening 11c.

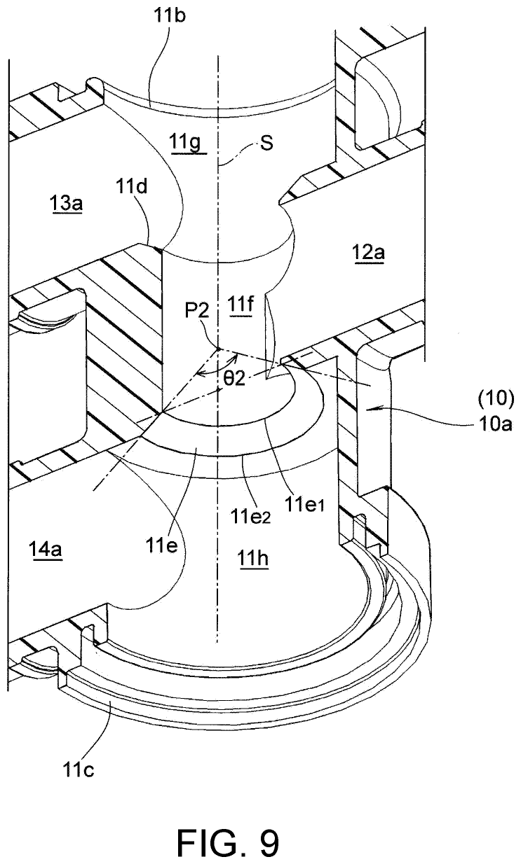

That is, as shown in FIG. 9, the second valve seat 11e is formed as a part of a conical surface that widens at an apex angle θ2 from an apex P2 located near the central chamber 11f toward the side of the second working chamber 11h on the axis S, and is defined by a circular inner edge 11e₁ and a circular outer edge 11e₂.

Here, the apex angle θ2 is formed in a range of about 110 degrees to 120 degrees, for example, and is set to about 115 degrees here.

In this embodiment, the first valve seat 11d and the second valve seat 11e are formed to be plane symmetrical with respect to a plane perpendicular to the axis S.

The central chamber 11f is formed between the first valve seat 11d and the second valve seat 11e in the direction of the axis S, communicates with an upstream passage 12a defined by the upstream pipe portion 12, and also functions as an upstream passage located upstream of the first valve seat 11d and the second valve seat 11e.

The first working chamber 11g is formed downstream of the first valve seat 11d, is a region in which the first valve body 20 reciprocates in the direction of the axis S, communicates with a first downstream passage 13a defined by the first downstream pipe portion 13, and also functions as a first downstream passage located downstream of the first valve seat 11d.

The second working chamber 11h is formed downstream of the second valve seat 11e, is a region in which the second valve body 30 reciprocates in the direction of the axis S, communicates with a second downstream passage 14a defined by the second downstream pipe portion 14, and also functions as a second downstream passage located downstream of the second valve seat 11e.

The upstream pipe portion 12 is a region to which a fluid inlet pipe of the applicable object (here, an inlet pipe forming a part of the cooling water circulation system) is connected, and defines the upstream passage 12a that has a circular cross section centered on an axis L1 perpendicular to the axis S.

The first downstream pipe portion 13 is a region to which a fluid outlet pipe of the applicable object (here, an outlet pipe forming a part of the cooling water circulation system) is connected, and defines the first downstream passage 13a that has a circular cross section centered on an axis L2 perpendicular to the axis S.

The second downstream pipe portion 14 is a region to which another fluid outlet pipe of the applicable object (here, another outlet pipe forming a part of the cooling water circulation system) is connected, and defines the second downstream passage 14a that has a circular cross section centered on an axis L3 perpendicular to the axis S.

The flange portion 15 is a region where the drive unit U is joined and fixed, and is formed in a substantially rectangular outline around the first opening 11b. The flange portion 15 includes the joint surface 15a that forms a flat surface perpendicular to the axis S, an annular groove 15b into which the sealing member 40 is fitted, a positioning protrusion 15c that protrudes from the joint surface 15a in the direction of the axis S, and four female screw holes 15d into which fastening screws b are screwed.

The cover coupling portion 16 is a region where the housing cover 10b is coupled, and includes an annular groove 16a centered on the axis S around the second opening 11c, and an annular joint surface 16b around the annular groove 16a.

The housing cover 10b is coupled to the cover coupling portion 16 to close the second working chamber 11h, and includes a disc-shaped lid portion 10b₁ that fits into the second opening 11c, an annular protrusion 10b₂ that fits into the annular groove 16a, and an annular joint surface 10b₃ that joins the annular joint surface 16b.

Then, when assembling the valve device, after the second valve body 30 is fitted and fixed to the shaft 60 of the drive unit U, the housing cover 10b is fitted to the cover coupling portion 16 of the housing body 10a, and is coupled by adhesion, welding or the like, as necessary.

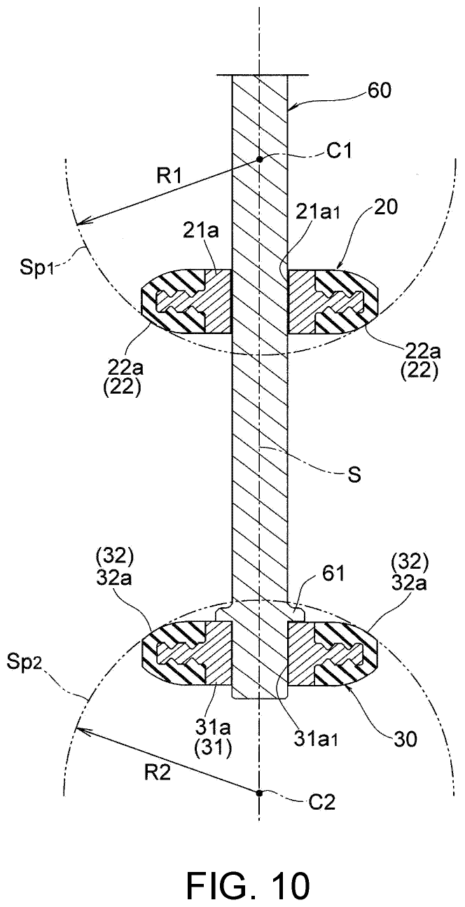

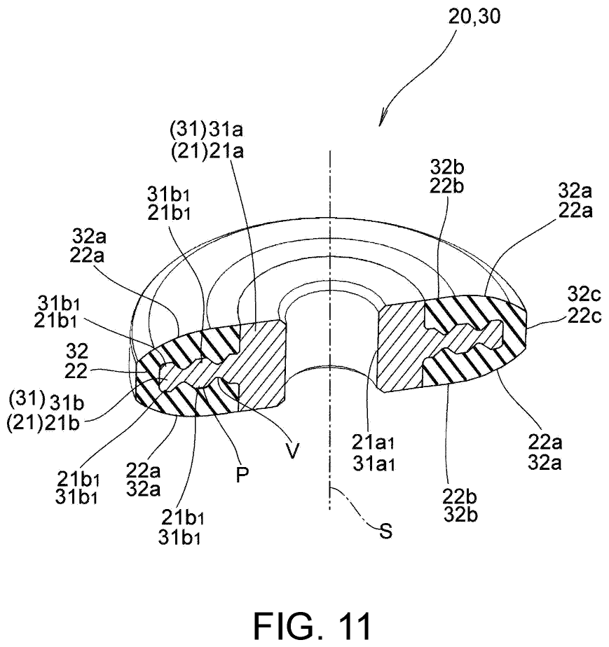

As shown in FIG. 10 to FIG. 12, the first valve body 20 includes a valve base member 21 that is fitted and fixed to a predetermined position of the shaft 60 of the drive unit U and is formed using a metal material such as stainless steel or a resin material, and an elastic sealing member 22 that is molded to cover the valve base member 21.

The valve base member 21 is formed by a hub portion 21a fixed to the shaft 60, and an annular plate portion 21b extending in a radial direction perpendicular to the axis S from the outer periphery of the hub portion 21a.

The hub portion 21a is formed into a cylindrical shape defining a fitting hole 21a1 centered on the axis S. The annular plate portion 21b includes a plurality of annular protrusions 21b1 concentrically centered on the axis S on both sides in the direction of the axis S. Then, uneven surfaces are defined on both sides of the valve base member 21 by the tops P and the troughs V defined by the plurality of annular protrusions 21b1.

The elastic sealing member 22 is joined using a rubber material or the like so as to cover the annular plate portion 21b of the valve base member 21, that is, molded to the valve base member 21 so as to be fixed to the valve base member 21 via a region including the uneven surfaces of the annular plate portion 21b.

Then, the elastic sealing member 22 is formed to include a convex curved surface 22a that is convex outward on both sides in the direction of the axis S, an annular flat surface 22b, and an outer peripheral edge 22c that forms a cylindrical surface.

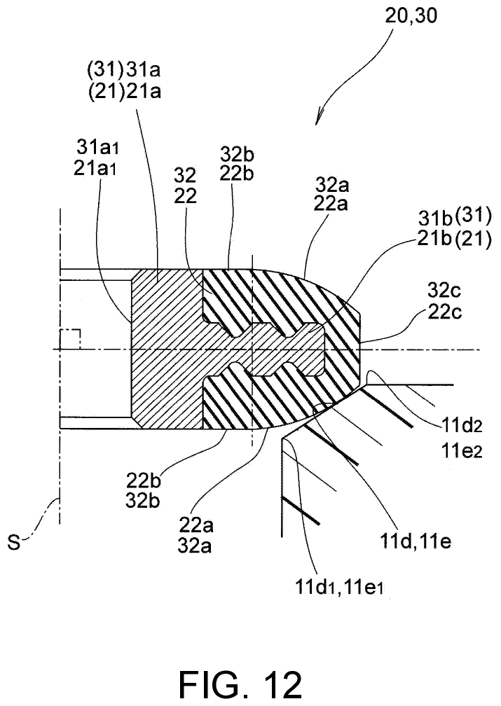

Here, the convex curved surface 22a is a curved surface having a predetermined curvature, and is formed to have a center C1 on the axis S and include a part of a spherical surface Sp₁ having a radius R1, as shown in FIG. 10, for example. Further, the convex curved surface 22a is formed to extend over a predetermined range from the outer peripheral edge 22c toward the inside in the radial direction, here, as shown in FIG. 12, to the inside in the radial direction beyond the circular inner edge 11d1 of the first valve seat 11d.

The flat surface 22b is formed at the same height position as the height dimension of the hub portion 21a of the valve base member 21 in the direction of the axis S.

The outer peripheral edge 22c is formed to have an outer diameter equal to or smaller than the diameter (diameter perpendicular to the axis S) of the circular outer edge 11d₂ of the first valve seat 11d. That is, the outer diameter dimension of the first valve body 20 is formed to be the same as or smaller than the outer diameter dimension of the first valve seat 11d.

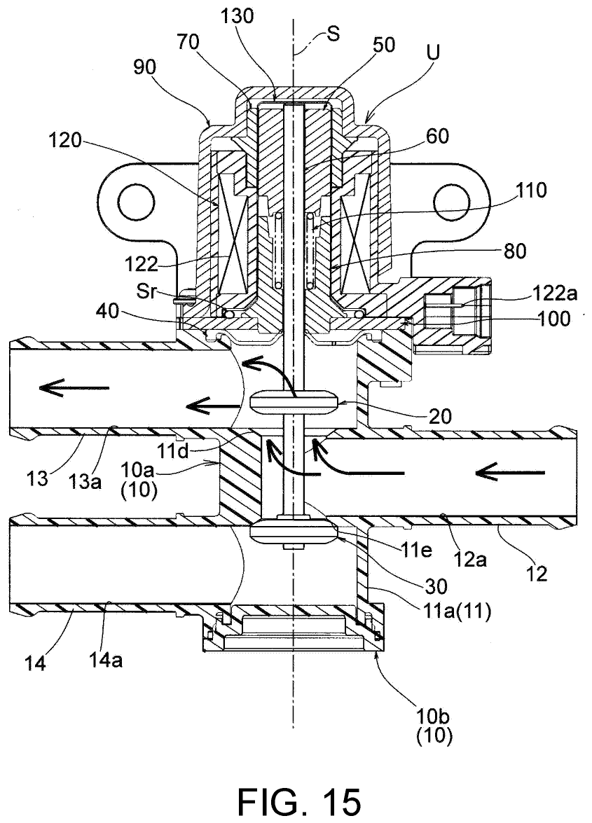

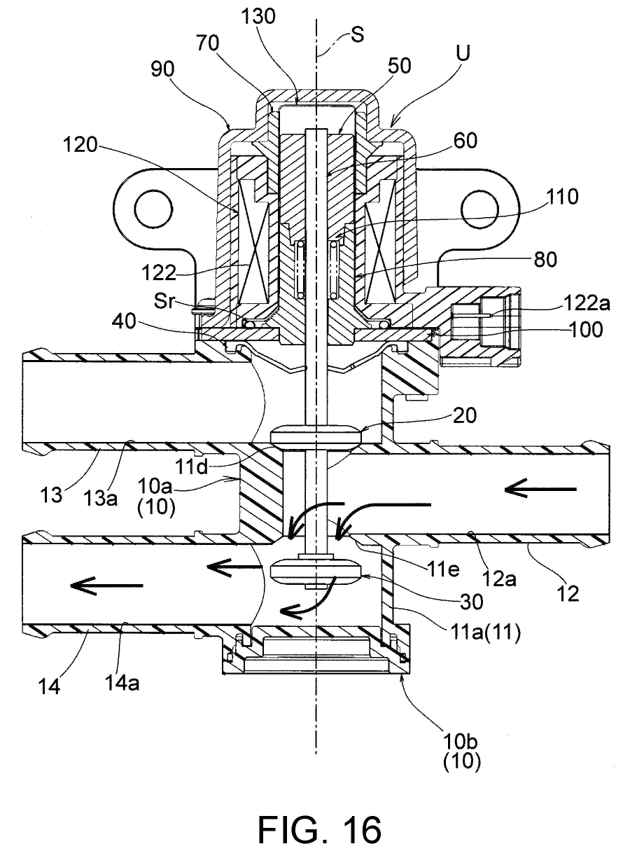

In the first valve body 20 having the above configuration, the convex curved surface 22a of the elastic sealing member 22 is in close contact with the first valve seat 11d at the valve-closed position. That is, the first valve body 20 is separated from the first valve seat 11d and opens the valve at the rest position shown in FIG. 15, and is seated on the first valve seat 11d and closes the valve at the operating position shown in FIG. 16.

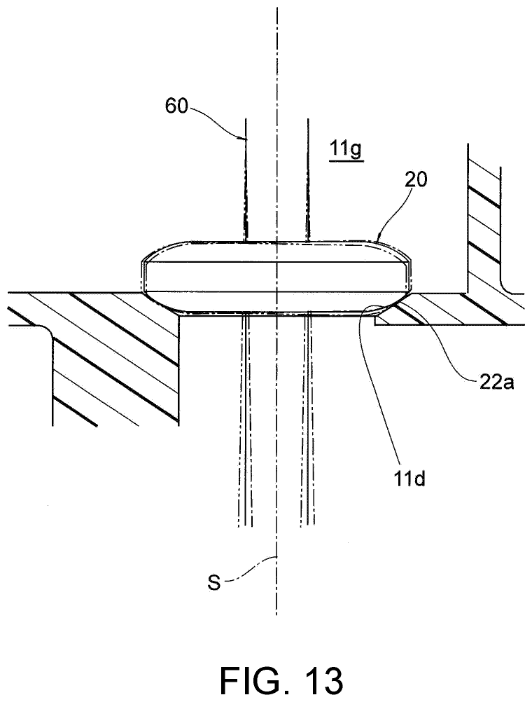

Here, since the first valve body 20 is formed to include the convex curved surface 22a that comes into contact with the annular tapered surface as the first valve seat 11d, even if the first valve body 20 is seated on the first valve seat 11d with the shaft 60 tilted or off-axis, as indicated by the one-dot chain line and the two-dot chain line in FIG. 13, the convex curved surface 22a is reliably in close contact with the annular tapered surface to ensure airtightness.

In particular, since the convex curved surface 22a is formed to include a part of the spherical surface having the center C1 on the axis S, even if the first valve body 20 is seated with the shaft 60 tilted, close contact can be ensured to close the valve.

Furthermore, since the first valve body 20 is formed to have an outer diameter equal to or smaller than the diameter of the circular outer edge 11d₂ of the first valve seat 11d, even if the first valve body 20 is seated with the shaft 60 tilted, the outer peripheral edge 22c of the first valve body 20 does not ride on the outside of the first valve seat 11d, and close contact can be ensured to close the valve.

Moreover, since the first valve body 20 is fixed by joining the elastic sealing member 22 to the valve base member 21 via the region including the uneven surfaces, compared to a case of simply joining to a flat surface, the adhesion surface increases, and the mechanical bonding strength can be increased due to an anchor effect or the like.

Further, the elastic sealing member 22 and the hub portion 21a are formed to have the same thickness dimension in the direction of the axis S. That is, since the outer contour of the first valve body 20 is formed as a continuous integral surface, the bonding strength therebetween can be increased compared to a configuration having a discontinuous step, and even if the shaft 60 is tilted, the region inside the convex curved surface 22a does not interfere with the first valve seat 11d, and the valve-closing operation can be performed reliably while achieving thinness and size reduction.

Furthermore, the first valve body 20 is formed to be rotationally symmetrical around the axis S and plane symmetrical with respect to a plane perpendicular to the axis S. Therefore, the first valve body 20 has no directionality with respect to the first valve seat 11d, and can be assembled so that either one of the convex curved surfaces 22a on both sides faces the first valve seat 11d, which facilitates the assembly work.

As shown in FIG. 10 to FIG. 12, the second valve body 30 is fitted and fixed at a position where the second valve body 30 abuts against a positioning portion 61 of the shaft 60 of the drive unit U, and includes a valve base member 31 that is formed using a metal material such as stainless steel or a resin material, and an elastic sealing member 32 that is molded to cover the valve base member 31.

The valve base member 31 is formed by a hub portion 31a fixed to the shaft 60, and an annular plate portion 31b extending in the radial direction perpendicular to the axis S from the outer periphery of the hub portion 31a.

The hub portion 31a is formed into a cylindrical shape defining a fitting hole 31a1 centered on the axis S. The annular plate portion 31b includes a plurality of annular protrusions 31b1 concentrically centered on the axis S on both sides in the direction of the axis S. Then, uneven surfaces are defined on both sides of the valve base member 31 by the tops P and the troughs V defined by the plurality of annular protrusions 31b1.

The elastic sealing member 32 is joined using a rubber material or the like so as to cover the annular plate portion 31b of the valve base member 31, that is, molded to the valve base member 31 so as to be fixed to the valve base member 31 via a region including the uneven surfaces of the annular plate portion 31b.

Then, the elastic sealing member 32 is formed to include a convex curved surface 32a that is convex outward on both sides in the direction of the axis S, an annular flat surface 32b, and an outer peripheral edge 32c that forms a cylindrical surface.

Here, the convex curved surface 32a is a curved surface having a predetermined curvature, and is formed to have a center C2 on the axis S and include a part of a spherical surface Sp₂ having a radius R2, as shown in FIG. 10, for example. Further, the convex curved surface 32a is formed to extend over a predetermined range from the outer peripheral edge 32c toward the inside in the radial direction, here, as shown in FIG. 12, to the inside in the radial direction beyond the circular inner edge 11e₁ of the second valve seat 11e.

The flat surface 32b is formed at the same height position as the height dimension of the hub portion 31a of the valve base member 31 in the direction of the axis S.

The outer peripheral edge 32c is formed to have an outer diameter equal to or smaller than the diameter (diameter perpendicular to the axis S) of the circular outer edge 11e₂ of the second valve seat 11e. That is, the outer diameter dimension of the second valve body 30 is formed to be the same as or smaller than the outer diameter dimension of the second valve seat 11e.

In the second valve body 30 having the above configuration, the convex curved surface 32a of the elastic sealing member 32 is in close contact with the second valve seat 11e at the valve-closed position. That is, the second valve body 30 is seated on the second valve seat 11e and closes the valve at the rest position shown in FIG. 15, and is separated from the first valve seat 11d and opens the valve at the operating position shown in FIG. 16.

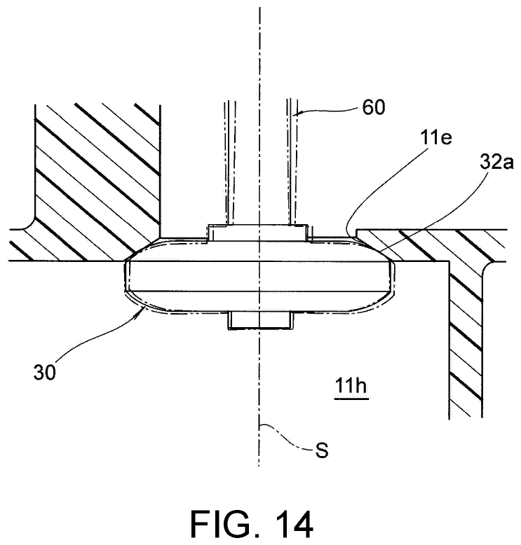

Here, since the second valve body 30 is formed to include the convex curved surface 32a that comes into contact with the annular tapered surface as the second valve seat 11e, even if the second valve body 30 is seated on the second valve seat 11e with the shaft 60 tilted or off-axis, as indicated by the one-dot chain line and the two-dot chain line in FIG. 14, the convex curved surface 32a is reliably in close contact with the annular tapered surface to ensure airtightness.

In particular, since the convex curved surface 32a is formed to include a part of the spherical surface having the center C2 on the axis S, even if the second valve body 30 is seated with the shaft 60 tilted, close contact can be ensured to close the valve.

Furthermore, since the second valve body 30 is formed to have an outer diameter equal to or smaller than the diameter of the circular outer edge 11e₂ of the second valve seat 11e, even if the second valve body 30 is seated with the shaft 60 tilted, the outer peripheral edge 32c of the second valve body 30 does not ride on the outside of the second valve seat 11e, and close contact can be ensured to close the valve.

Moreover, since the second valve body 30 is fixed by joining the elastic sealing member 32 to the valve base member 31 via the region including the uneven surfaces, compared to a case of simply joining to a flat surface, the adhesion surface increases, and the mechanical bonding strength can be increased due to an anchor effect or the like.

Further, the elastic sealing member 32 and the hub portion 31a are formed to have the same thickness dimension in the direction of the axis S. That is, since the outer contour of the second valve body 30 is formed as a continuous integral surface, the bonding strength therebetween can be increased compared to a configuration having a discontinuous step, and even if the shaft 60 is tilted, the region inside the convex curved surface 32a does not interfere with the second valve seat 11e, and the valve-closing operation can be performed reliably while achieving thinness and size reduction.

Furthermore, the second valve body 30 is formed to be rotationally symmetrical around the axis S and plane symmetrical with respect to a plane perpendicular to the axis S. Therefore, the second valve body 30 has no directionality with respect to the second valve seat 11e, and can be assembled so that either one of the convex curved surfaces 32a on both sides faces the second valve seat 11e, which facilitates the assembly work.

Here, as described above, the first valve body 20 and the second valve body 30 are formed by the valve base members 21 and 31 having the same structure and form, and the elastic sealing members 22 and 32 having the same structure and form. That is to say, since the parts serving as the first valve body 20 and the second valve body 30 have the same shape (form), compared to a case where separate parts are used, management man-hours can be reduced and costs can be reduced.

If the first valve body and the second valve body have convex curved surfaces, they do not need to be the same part, and may be formed in different forms depending on the specifications of the first valve seat and the second valve seat, which form the annular tapered surfaces of the valve device.

As described above, the first valve body 20 and the second valve body 30 are arranged apart from each other in the direction of the axis S with respect to the shaft 60, and due to the reciprocating movement of the shaft 60, the first valve body 20 reciprocates within the first working chamber 11g to be seated on and separated from the first valve seat 11d, and the second valve body 30 reciprocates within the second working chamber 11h to be seated on and separated from the second valve seat 11e.

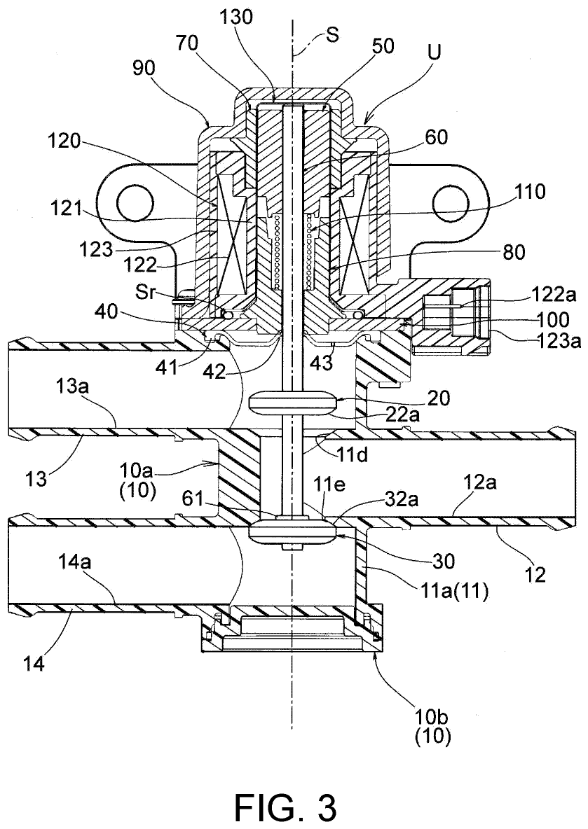

The sealing member 40 is formed into a disc shape using an elastically deformable thin film rubber material, and includes an annular fitting portion 41, a central connecting portion 42, and a communication hole 43, as shown in FIG. 3.

The communication hole 43 is formed in a size that does not allow foreign matter to pass through, and contributes to a pressure regulation effect as a ventilation hole.

Then, the sealing member 40 is connected by passing the shaft 60 of the drive unit U through the central connecting portion 42, the annular fitting portion 41 is fitted into the annular groove 15b of the housing 10, and the sealing member 40 is held by joining a flat yoke 100 of the drive unit U.

In this assembled state, the sealing member 40 performs a sealing function at the joint interface between the housing 10 and the drive unit U, and is elastically deformed to move integrally with the shaft 60 and prevents foreign matter in the fluid from entering the side of the drive unit U. In addition, the sealing member 40 provides a pressure regulation effect through the communication hole 43 when elastically deformed so as not to inhibit the movement of the shaft 60.

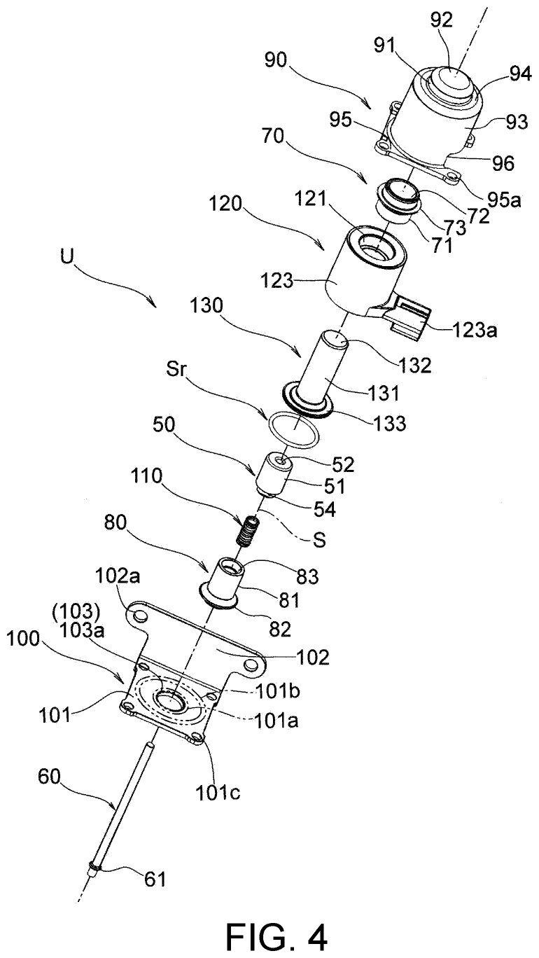

As shown in FIG. 3 and FIG. 4, the drive unit U includes a movable element 50, the shaft 60, a first inner yoke 70, a second inner yoke 80, a cylindrical yoke 90 and a flat yoke 100, an urging spring 110, a coil module 120, a cylindrical member 130, and a sealing member Sr.

In addition, the coil module 120 includes a bobbin 121, an excitation coil 122, and a molded portion 123 in which the bobbin 121 and the coil 122 are embedded.

Further, the first inner yoke 70, the second inner yoke 80, the cylindrical yoke 90, and the flat yoke 100 function as a stator that forms a magnetic path.

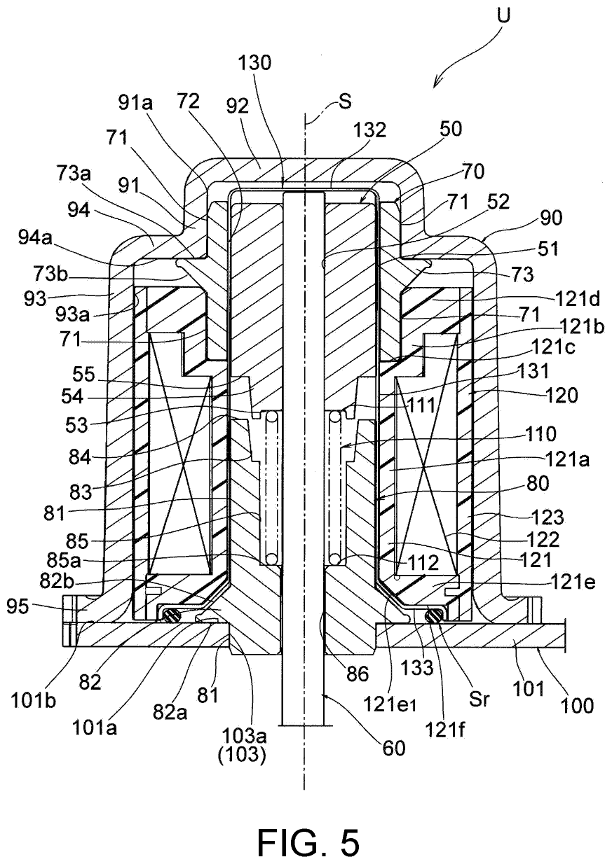

The movable element 50 functions as a magnetic path for passing lines of magnetic force and also functions as a movable iron core that moves in the direction of the axis S when the coil 122 is energized, and is formed into a cylindrical shape by machining or forging using free-cutting steel (SUM) or the like. As shown in FIG. 4 and FIG. 5, the movable element 50 includes an outer peripheral surface 51, a fitting hole 52, a spring receiving portion 53, a convex portion 54, and an annular end surface 55.

The outer peripheral surface 51 is formed as a cylindrical surface centered on the axis S, and is slidably in contact with the inner wall of the cylindrical member 130.

The fitting hole 52 is a through hole centered on the axis S and is a region into which one end side region of the shaft 60 is press-fitted. The fitting hole 52 is formed to have an inner diameter slightly smaller than the outer diameter dimension of the shaft 60.

The spring receiving portion 53 is formed into a circular concave portion centered on the axis S, receives one end portion 111 of the urging spring 110, and positions the one end portion 111 in a direction perpendicular to the axis S.

The convex portion 54 is formed into a truncated cone shape, and is formed to fit into a concave portion 83 of the second inner yoke 80 in a non-contact manner.

The annular end surface 55 is formed as a flat surface perpendicular to the axis S, and faces an annular end surface 84 of the second inner yoke 80 in the direction of the axis S.

In addition, in order to make the movement of the movable element 50 smooth, for example, a slot extending in the direction of the axis S may be formed on the outer peripheral surface so as to adjust the front and rear pressures when the movable element 50 moves.

The shaft 60 is formed into a long columnar shape in the direction of the axis S using a non-magnetic material, for example, a metal material such as stainless steel or a resin material, and includes the positioning portion 61 near the other end side.

As shown in FIG. 3, FIG. 4, and FIG. 10, the positioning portion 61 is formed into a brim shape that protrudes in the radial direction, and abuts against and positions the second valve body 30 in the direction of the axis S.

By providing the positioning portion 61 in this way, when the second valve body 30 is fitted and fixed to the shaft 60 inside the housing body 10a, the second valve body 30 can be easily positioned at a predetermined position on the shaft 60 simply by abutting against the positioning portion 61.

Then, the shaft 60 is fixed to the movable element 50 by fitting one end side region into the fitting hole 52. Further, the central connecting portion 42 of the sealing member 40 is connected to the shaft 60 approximately at the center in the direction of the axis S, the first valve body 20 is fixed by fitting at a position closer to the other end (free end) side than the center in the direction of the axis S, and the second valve body 30 is fixed by fitting so as to abut against the positioning portion 61 on the other end side.

Then, the shaft 60 reciprocates in the direction of the axis S integrally with the movable element 50, the first valve body 20, and the second valve body 30.

The first inner yoke 70 is formed by machining or forging using soft iron or the like, and functions as a magnetic path for passing lines of magnetic force. As shown in FIG. 4 and FIG. 5, the first inner yoke 70 is formed into a cylindrical shape, and includes a first outer peripheral surface 71, an inner peripheral surface 72, and a first annular brim portion 73.

The first outer peripheral surface 71 is formed as a cylindrical surface centered on the axis S, and is formed to be fitted into the inner peripheral surface 91a of the small-diameter cylindrical portion 91 of the cylindrical yoke 90 and fitted into the bobbin 121 of the coil module 120.

The inner peripheral surface 72 is formed as a cylindrical surface centered on the axis S, and is formed so that the cylindrical member 130 is fitted therein.

The first annular brim portion 73 is formed into a disc shape that protrudes in the radial direction perpendicular to the axis S from the first outer peripheral surface 71, and includes an annular flat surface 73a and an annular tapered surface 73b.

The annular flat surface 73a is a flat surface perpendicular to the axis S, and is joined to an annular joint surface 94a of the cylindrical yoke 90 in the direction of the axis S.

The annular tapered surface 73b is formed on the side opposite to the annular flat surface 73a, and is formed to widen toward the annular joint surface 94a of the cylindrical yoke 90.

The second inner yoke 80 is formed by machining or forging using soft iron or the like, and functions as a magnetic path for passing lines of magnetic force and also functions as a fixed iron core that attracts the movable element 50 when the coil 122 is energized. As shown in FIG. 4 and FIG. 5, the second inner yoke 80 is formed into a cylindrical shape, and includes a second outer peripheral surface 81, a second annular brim portion 82, a concave portion 83, an annular end surface 84, a spring housing concave portion 85, and a guide hole 86.

The second outer peripheral surface 81 is formed as a cylindrical surface centered on the axis S, and is formed to be fitted into the bobbin 121 of the coil module 120 via the cylindrical member 130 and fitted into the fitting hole 103 of the flat yoke 100.

The second annular brim portion 82 is formed into a disc shape that protrudes in the radial direction perpendicular to the axis S from the second outer peripheral surface 81, and includes an annular flat surface 82a and an annular tapered surface 82b.

The annular flat surface 82a is a flat surface perpendicular to the axis S, and is joined to the annular joint surface 101a of the flat yoke 100 in the direction of the axis S.

The annular tapered surface 82b is formed on the side opposite to the annular flat surface 82a, and is formed to widen toward the annular joint surface 101a of the flat yoke 100.

The concave portion 83 is formed into a truncated cone shape, and is formed to receive the convex portion 54 of the movable element 50 in a non-contact manner in the direction of the axis S.

The annular end surface 84 is formed as a flat surface perpendicular to the axis S, and faces the annular end surface 55 of the movable element 50 in the direction of the axis S.

The spring housing concave portion 85 is formed to have a smaller diameter than the concave portion 83 and receives the urging spring 110, and includes a spring receiving portion 85a that receives the other end portion 112 of the urging spring 110.

The guide hole 86 is formed as a cylindrical hole centered on the axis S, and guides the shaft 60 slidably in the direction of the axis S.

The cylindrical yoke 90 is a press-molded product that is press-formed (deep-drawn) into a bottomed cylindrical shape using a metal plate such as soft iron having a predetermined thickness so as to function as a magnetic path for passing lines of magnetic force. As shown in FIG. 1, FIG. 4, and FIG. 5, the cylindrical yoke 90 includes a small-diameter cylindrical portion 91, a bottom wall 92, a large-diameter cylindrical portion 93, an annular flat plate portion 94, a flange portion 95, and a cutout portion 96.

The small-diameter cylindrical portion 91 defines the inner peripheral surface 91a centered on the axis S. The first outer peripheral surface 71 of the first inner yoke 70 is fitted into the inner peripheral surface 91a. That is, the first inner yoke 70 is joined and fixed to the cylindrical yoke 90 in the radial direction perpendicular to the axis S via the inner peripheral surface 91a of the small-diameter cylindrical portion 91.

The bottom wall 92 is formed continuously with the end portion of the small-diameter cylindrical portion 91 in the direction of the axis S, and is arranged without contacting the cylindrical member 130.

The large-diameter cylindrical portion 93 defines an inner peripheral surface 93a centered on the axis S. The molded portion 123 of the coil module 120 is fitted into the inner peripheral surface 93a.

The annular flat plate portion 94 is formed continuously in the boundary region between the small-diameter cylindrical portion 91 and the large-diameter cylindrical portion 93, and defines the annular joint surface 94a to which the annular flat surface 73a of the first inner yoke 70 is joined in the direction of the axis S.

The flange portion 95 is formed into a substantially rectangular shape continuously from the end portion of the large-diameter cylindrical portion 93, and includes four circular holes 95a through which the fastening screws b pass. Then, in the assembled state, the flange portion 95 is joined to the flat yoke 100 to form a magnetic path.

The cutout portion 96 is formed to expose a connector 123a of the coil module 120 to the outside.

The flat yoke 100 is punched and bent using a metal plate such as soft iron having a predetermined thickness so as to be joined to the open end of the cylindrical yoke 90 and function as a magnetic path for passing lines of magnetic force. As shown in FIG. 4 and FIG. 5, the flat yoke 100 includes a substantially rectangular flat plate portion 101, an attachment portion 102 bent from the flat plate portion 101 and extending in the direction of the axis S, and a fitting hole 103.

The flat plate portion 101 includes an annular joint surface 101a to which the annular flat surface 82a of the second inner yoke 80 is closely joined in the direction of the axis S, an annular joint surface 101b to which the flange portion 95 of the cylindrical yoke 90 is closely joined in the direction of the axis S, and four circular holes 101c through which the fastening screws b pass.

The attachment portion 102 is used to attach the valve device to the applicable object, and includes two circular holes 102a through which fixing bolts pass.

The fitting hole 103 is a region into which the second outer peripheral surface 81 of the second inner yoke 80 is fitted, and defines a cylindrical inner peripheral surface 103a centered on the axis S. The inner peripheral surface 103a is closely joined to the second outer peripheral surface 81 of the second inner yoke 80 in the radial direction perpendicular to the axis S.

That is, the second inner yoke 80 is joined and fixed to the flat yoke 100 in the radial direction perpendicular to the axis S via the inner peripheral surface 103a of the fitting hole 103.

The urging spring 110 is a compression type coil spring, and is arranged to be compressed in the direction of the axis S with one end portion 111 abutting against the spring receiving portion 53 of the movable element 50 and the other end portion 112 abutting against the spring receiving portion 85a of the second inner yoke 80. Then, the urging spring 110 urges the movable element 50 toward the rest position in the direction of the axis S.

As described above, the coil module 120 includes the bobbin 121, the excitation coil 122, and the molded portion 123.

The bobbin 121 is formed using a resin material, and as shown in FIG. 5, the bobbin 121 includes a small-diameter cylindrical portion 121a centered on the axis S, a large-diameter cylindrical portion 121b, an annular step portion 121c, a flange portion 121d, a flange portion 121e, and a concave portion 121f.

The small-diameter cylindrical portion 121a is formed so that the cylindrical member 130 is fitted inside the small-diameter cylindrical portion 121a, and the coil 122 is wound around the outside thereof.

The large-diameter cylindrical portion 121b is formed so that the first outer peripheral surface 71 of the first inner yoke 70 is fitted inside the large-diameter cylindrical portion 121b, and the coil 122 is wound around the outside thereof.

The annular step portion 121c abuts against the end surface of the first inner yoke 70 so as to be positioned in the direction of the axis S in the assembled state.

The flange portion 121d is formed into an annular shape centered on the axis S, and is arranged to face the first annular brim portion 73 (annular tapered surface 73b) of the first inner yoke 70 and the annular flat plate portion 94 of the cylindrical yoke 90 in the direction of the axis S.

The flange portion 121e is formed into an annular shape centered on the axis S, defines an annular tapered surface 121e₁ in the root region thereof, and is arranged to face the flat yoke 100 in the direction of the axis S and receive the flange portion 133 of the cylindrical member 130.

The concave portion 121f is formed to receive the flange portion 133 of the cylindrical member 130 and receive the sealing member Sr.

The coil 122 is used for excitation to generate magnetic force when energized, and is wound around the small-diameter cylindrical portion 121a and the large-diameter cylindrical portion 121b of the bobbin 121 and connected to two terminals 122a.

The molded portion 123 is molded using a resin material, and is molded to cover the entire body and expose the terminals 122a inside the connector 123a in a state where the coil 122 is wound around the bobbin 121 and the terminals 122a are connected.

The cylindrical member 130 is press-formed (deep-drawn) into a bottomed cylindrical shape using a thin metal plate made of a non-magnetic material such as stainless steel. As shown in FIG. 4 and FIG. 5, the cylindrical member 130 includes a cylindrical portion 131 centered on the axis S, a bottom wall 132, and a flange portion 133.

The cylindrical portion 131 is formed so that the outer peripheral surface 51 of the movable element 50 is slidably inserted into the cylindrical portion 131 and the second outer peripheral surface 81 of the second inner yoke 80 is fitted into the cylindrical portion 131, and the inner peripheral surface 72 of the first inner yoke 70 and the small-diameter cylindrical portion 121a of the bobbin 121 of the coil module 120 are fitted to the outside thereof.

The bottom wall 132 is arranged so that the movable element 50 and the shaft 60 are not in contact with each other in the rest state.

The flange portion 133 abuts against the flange portion 121e of the bobbin 121 of the coil module 120 to be positioned in the direction of the axis S.

Then, in the assembled state, the cylindrical member 130 houses the movable element 50 and the second inner yoke 80, and exposes the shaft 60 fixed to the movable element 50 to the outside, here, to the internal space of the housing 10 (the first working chamber 11g, the central chamber 11f, and the second working chamber 11h).

That is, the cylindrical member 130 has the function of slidably guiding the movable element 50, and isolating the internal region in which the movable element 50 operates from the external region to prevent fluid from leaking to the outside.

The sealing member Sr is an O-ring made of a rubber material, and is interposed between the flange portion 133 of the cylindrical member 130 and the flat yoke 100 in the assembled state to seal and prevent fluid from leaking to the outside.

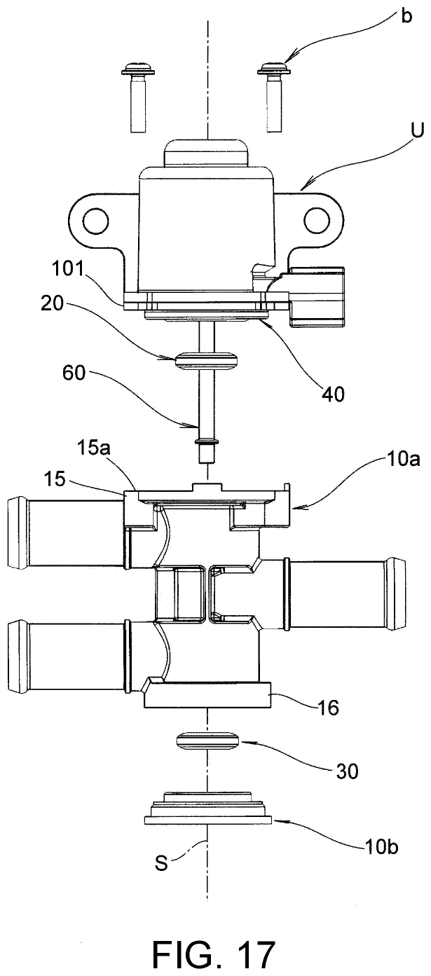

Next, the assembly work of the valve device having the above configuration will be described with reference to FIG. 17 to FIG. 20.

First, prior to assembling the valve device, the drive unit U is assembled. In this assembly step, the first valve body 20 is fitted and fixed at a predetermined position with respect to the shaft 60, and the central connecting portion 42 of the sealing member 40 is connected. Thereafter, the shaft 60 is fitted and fixed to the movable element 50.

Then, as shown in FIG. 17, the drive unit U incorporating the first valve body 20 and the sealing member 40, the housing body 10a, the second valve body 30, the housing cover 10b, and four fastening screws b are prepared.

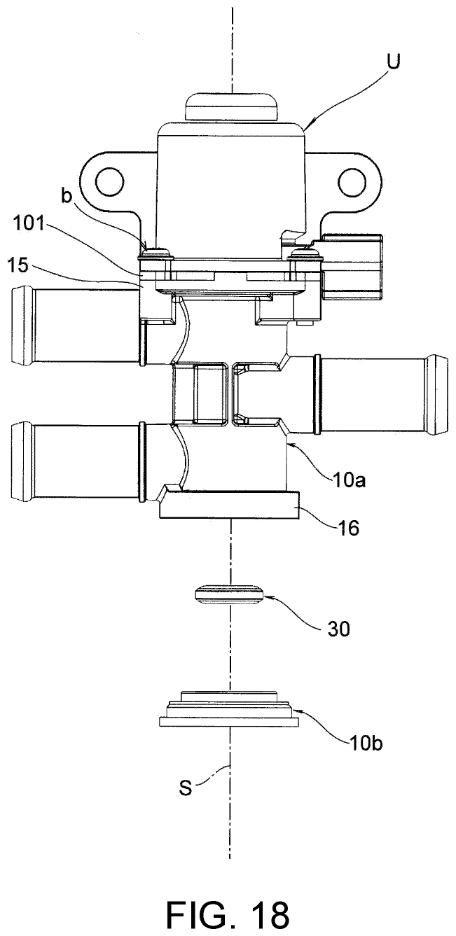

Subsequently, the shaft 60 and the first valve body 20 are inserted into the housing body 10a through the first opening 11b, and the annular fitting portion 41 of the sealing member 40 is fitted into the annular groove 15b, and as shown in FIG. 18, the flat plate portion 101 of the flat yoke 100 is joined to the joint surface 15a of the flange portion 15. Then, the fastening screws b are screwed into the female screw holes 15d of the housing body 10a through the circular holes 95a and 101c.

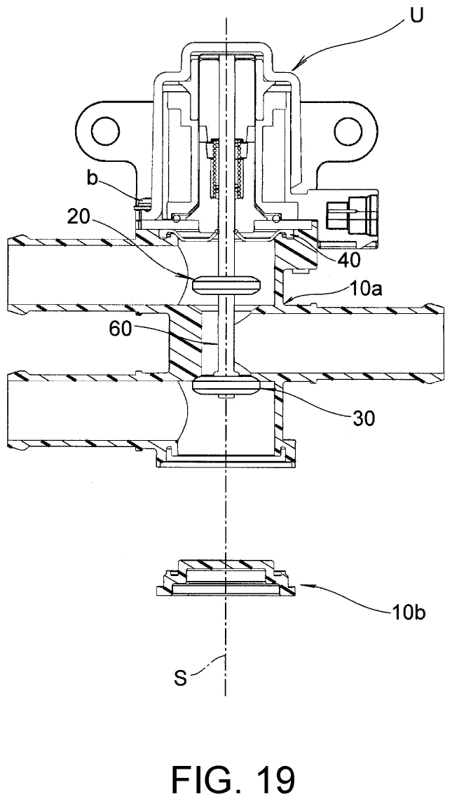

Subsequently, as shown in FIG. 19, the second valve body 30 is inserted into the housing body 10a through the second opening 11c, and while the shaft 60 is held using a predetermined jig inserted from the upstream passage 12a or the first downstream passage 13a, the shaft 60 is fitted and fixed so as to abut against the positioning portion 61.

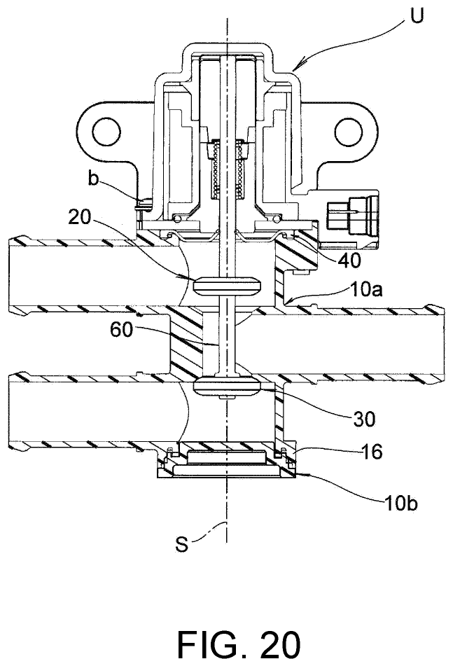

Subsequently, as shown in FIG. 20, the housing cover 10b is fitted and fixed to the cover coupling portion 16 of the housing body 10a. It should be noted that the housing cover 10b may be fixed using an adhesive or the like as appropriate.

The above procedure completes the assembly of the valve device. This assembly procedure is merely an example, and the assembly may be performed by other methods and procedures.

Next, the operation of the valve device according to an embodiment will be described.

First, in the state where the coil 122 is not energized, the movable element 50 and the shaft 60 are located at the rest position due to the urging force of the urging spring 110, as shown in FIG. 15. At this rest position, the first valve body 20 is separated from the first valve seat 11d to open the valve, and the second valve body 30 is seated on the second valve seat 11e to close the valve.

Therefore, the fluid flowing from the upstream passage 12a flows into the first downstream passage 13a via the central chamber 11f and the first working chamber 11g.

On the other hand, when the coil 122 is energized, electromagnetic force is generated, and as shown in FIG. 16, the movable element 50 is attracted to the second inner yoke 80, and the movable element 50 and the shaft 60 are located at the operating position against the urging force of the urging spring 110. At this operating position, the first valve body 20 is seated on the first valve seat 11d to close the valve, and the second valve body 30 is separated from the second valve seat 11e to open the valve.

Therefore, the fluid flowing from the upstream passage 12a flows into the second downstream passage 14a via the central chamber 11f and the second working chamber 11h.

By switching the coil 122 between energization and de-energization in this way, the fluid can flow from the first downstream passage 13a toward an external fluid outlet pipe, or the fluid can flow from the second downstream passage 14a toward another external fluid outlet pipe.

Here, in the configuration including the housing 10 which have the first valve seat 11d and the second valve seat 11e formed into annular tapered surfaces that form a part of the conical surfaces centered on the axis S, and the first valve body 20 and the second valve body 30 which have the convex curved surfaces 22a and 32a to respectively contact the annular tapered surfaces of the first valve seat 11d and the second valve seat 11e, even if the shaft 60 moves slightly off-axis or tilted, the first valve body 20 can come into close contact with the first valve seat 11d to reliably close the valve, and the second valve body 30 can come into close contact with the second valve seat 11e to reliably close the valve.

Although the above embodiment illustrates a configuration including the first valve body 20 and the second valve body 30 as the valve body, the disclosure is not limited thereto, and a configuration in which one valve body is provided on the shaft may be adopted. In this case, the valve base member of the valve body and the shaft may be integrally made of a resin material, and the elastic sealing member may be molded onto the integrally formed valve base member of the shaft.

Although the above embodiment illustrates the first valve body 20 and the second valve body 30 constituted by the valve base members 21 and 31 and the elastic sealing members 22 and 32 as the valve body, the disclosure is not limited thereto, and a valve body made of a single material such as a metal material or a resin material may be adopted as long as the valve body includes a convex curved surface to come into contact with the valve seat that forms an annular tapered surface.

Although the above embodiment illustrates a valve body that is formed to be rotationally symmetrical around the axis S and plane symmetrical with respect to the plane perpendicular to the axis S (the first valve body 20 and the second valve body 30), the disclosure is not limited thereto, and the valve body may be formed to be asymmetrical with respect to the plane perpendicular to the axis S as long as the valve body includes the configuration of the disclosure.

Although the above embodiment illustrates a configuration in which the sealing member 40 having a structure similar to a diaphragm is adopted as a component of the valve device to prevent foreign matter in the fluid from entering the side of the drive unit U, the disclosure is not limited thereto, and the periphery of the shaft 60 may be sealed by fitting, for example, a lip-type seal at the end portion of the guide hole 86 of the second inner yoke. According to this, the pressure of the fluid does not act on the movable part, so the movable element and the valve body can be driven with smaller electromagnetic force.

As described above, according to the valve device of the disclosure, the valve body can be brought into close contact with the valve seat to reliably close the valve even if the shaft moves slightly off-axis or tilted. Therefore, the disclosure can not only be applied as a valve device in a cooling water circulation system of a vehicle or the like but is also useful as a valve device in other fields.

What is claimed is:

1. A valve device, comprising:
a housing that defines an upstream passage and a downstream passage through which a fluid passes, and a valve seat which is interposed between the upstream passage and the downstream passage;
a shaft that reciprocates along a predetermined axis; and
a valve body that is fixed to the shaft, and seated on and separated from the valve seat,
wherein the valve seat is formed into an annular tapered surface which forms a part of a conical surface centered on the axis, and
the valve body is formed to comprise a convex curved surface which comes into contact with the annular tapered surface when seated on the valve seat.

2. The valve device according to claim 1, wherein the convex curved surface is formed to comprise a part of a spherical surface which has a center on the axis.

3. The valve device according to claim 1, wherein the valve seat is defined by a circular inner edge and a circular outer edge centered on the axis,
the valve body comprises an outer peripheral edge which has an outer diameter equal to or smaller than a diameter of the circular outer edge, and
the convex curved surface is formed over a predetermined range which extends inward in a radial direction from the outer peripheral edge.

4. The valve device according to claim 1, wherein the valve body comprises a valve base member fixed to the shaft, and an elastic sealing member fixed to the valve base member, and
the convex curved surface is formed on the elastic sealing member.

5. The valve device according to claim 4, wherein the valve base member comprises a hub portion fixed to the shaft, and an annular plate portion extending from an outer periphery of the hub portion in a radial direction perpendicular to the axis, and
the elastic sealing member is joined to cover the annular plate portion.

6. The valve device according to claim 5, wherein the elastic sealing member and the hub portion are formed to have the same thickness dimension in a direction of the axis.

7. The valve device according to claim 4, wherein the valve base member comprises an uneven surface at a joint interface of the elastic sealing member.

8. The valve device according to claim 4, wherein the elastic sealing member is molded to the valve base member.

9. The valve device according to claim 1, wherein the valve body is formed to be rotationally symmetrical around the axis and plane symmetrical with respect to a plane perpendicular to the axis.

10. The valve device according to claim 1, wherein the downstream passage comprises a first downstream passage and a second downstream passage which branch from the upstream passage,
the valve seat comprises a first valve seat facing the first downstream passage and a second valve seat facing the second downstream passage, and
the valve body comprises a first valve body corresponding to the first valve seat and a second valve body corresponding to the second valve seat, wherein the first valve body and the second valve body are spaced apart from each other in a direction of the axis.

11. The valve device according to claim 10, wherein the first valve body is in an open state of being separated from the first valve seat in a state where the second valve body is in a closed state of being seated on the second valve seat, and
the second valve body is in an open state of being separated from the second valve seat in a state where the first valve body is in a closed state of being seated on the first valve seat.

12. The valve device according to claim 11, further comprising a drive unit that drives the shaft.

13. The valve device according to claim 12, wherein the drive unit comprises a movable element to which the shaft is fixed, an excitation coil, and a stator which forms a magnetic path, and
the shaft is made of a non-magnetic material.

14. The valve device according to claim 13, wherein the valve base member is made of a non-magnetic material, and
the elastic sealing member is made of a rubber material.

15. The valve device according to claim 12, wherein the first valve body and the second valve body are fixed to the shaft by fitting, and
the housing comprises:
a housing body that comprises:
a joint surface which joins the drive unit,
a first opening which is formed inside the joint surface and to which the first valve body is inserted from one side in the direction of the axis,
the first valve seat and the second valve seat which are sequentially arranged in the direction of the axis following the first opening, and
a second opening to which the second valve body is inserted from the other side in the direction of the axis; and
a housing cover that is coupled to the housing body so as to close the second opening.

16. The valve device according to claim 15, wherein the shaft comprises a positioning portion that positions the second valve body in the direction of the axis.
